(19) United States
(12) Patent Application Publication
(10) Pub. No.: US 2008/0100006 A1
(43) Pub. Date: May 1, 2008

(54) QUICK INSTALLMENT AND REMOVAL TOOL ANVIL AND ADAPTOR ASSEMBLY

(76) Inventor: Chih-Yaung CHU, Taichung City (TW)

Correspondence Address: Chih-Yaung CHU, 235 Chung-Ho, Box 8-24, Taipei, TW

(21) Appl. No.: 11/970,513

(22) Filed: Jan. 7, 2008

Related U.S. Application Data
(63) Continuation-in-part of application No. 11/098,696, filed on Apr. 5, 2005, now abandoned.

(51) Int. Cl. B23B 31/12

(52) U.S. Cl. 279/79

(57) ABSTRACT

A quick installment and removal tool anvil and adaptor assembly has an anvil and an adaptor. The anvil extends from the tool body of air/electric driving tool. The circumferential wall of the anvil is extended to the free end of the connection unit, and the circumference of anvil in the connection unit is equipped with the vertically concave dented groove. The adaptor comprises one shaft rod, two insert pins threaded through the shaft rod, one spring installed around the shaft rod, a washer installed between the spring and insert pin, and a cylinder body enclosing the shaft rod, the spring, washer and the insert pins, and a collar for stopping the shaft rod from slipping off. A tool body of air/electric driving tool in conjunction with the adaptors of different functions will receive multi-functions without the spending of buying different tools.

The invention is a continuation in part (CIP) of U.S. patent application Ser. No. 11/098,696 which is assigned and invented by the inventor of the present invention. Thus the content of the patent U.S. patent application Ser. No. 11/098,696 is incorporated into the present invention as a part of the present invention.

### FIELD OF THE INVENTION

The present invention relates to the technical field of portable air/electric driving tools about a quick installment and removal tool anvil and adaptor assembly.

### BACKGROUND OF THE INVENTION

The average air/electric driving tools are powered by high pressure air or electricity to let the inside rotor rotate so as to drive an anvil fast and cause the tools installed to the anvil, such as a socket, a sanding pad, and a drill bit.

Though the current air/electric driving tools are equipped with the anvils of different shapes, while the function thereof is just limited to one only.

For examples, the front end of the anvil for those air/electric driving tools connected with the socket to fasten or remove the bolts or nuts is square and provides the single function.

Moreover, the front end of the anvil for those air/electric driving tools for sanding is concave with hole-bolt and delivers a single function, too.

As such, an operator has to buy different air/electric driving tools for different functions, and more money is consumed.

In case of an apparatus being able to be quickly adapted to the air/electric driving tool and also has multi-functions, that design must be what the operators want.

### SUMMARY OF THE INVENTION

The object of the invention is to provide a quick installment and removal tool anvil and adaptor assembly to the operators for the improvement of air/electric driving tool limited to its single function.

The Anvil is designed with the local extrusion from the body of air/electric driving tool and the surface of anvil is possessed with the connection unit extended to the free end with the vertically concave dented groove; and the adaptor consists of one shaft rod, two insert pins, one spring, one washer, one cylinder body and one collar.

In order to let this invention be changed quickly and bear the high torque, the mechanism is involved with a mixture of hammer driving and connection force.

In other words, this invention is simultaneously mixed the mechanism of quick adaptor and the hammer mechanism of air/electric driving tool.

For arriving at the goal, the square anvil of traditional air/electric driving tool has been changed to an oval like double round and double flat one, while the double round is used for the connection and the double flat for the hammer driving.

Additionally, the length of double flat is extended to disperse the hammer force for bearing the high torque.

By means of the above-mentioned technical structure, this invention helps the operator change the adaptor for the air/electric driving tool possessed with the tool head depending on the working requirements.

That is, one air/electric driving tool can cover multi-functions by the change of different adaptors only for saving money buying different tools for different uses.

### BRIEF DESCRIPTION OF THE DRAWINGS

FIG. 1 is a schematic plain view showing a tool body and various adaptors,

FIG. 2 is a schematic elevation view of the adaptor according to the present invention.

FIG. 3 is a plain assembly view of an adaptor of the present invention which is illustrated by a cutaway schematic illustration,

FIG. 4 is a plain view and cutaway view of the adaptor and anvil of the present invention which are ready to be assembled,

FIG. 5 is a plain view and cutaway view of the adaptor and anvil of the present invention in the assembly process,

FIG. 6 is a plain view and cutaway view drawing of adaptor and anvil in the completed assembly.

### DETAILED DESCRIPTION OF THE PREFERRED EMBODIMENT

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

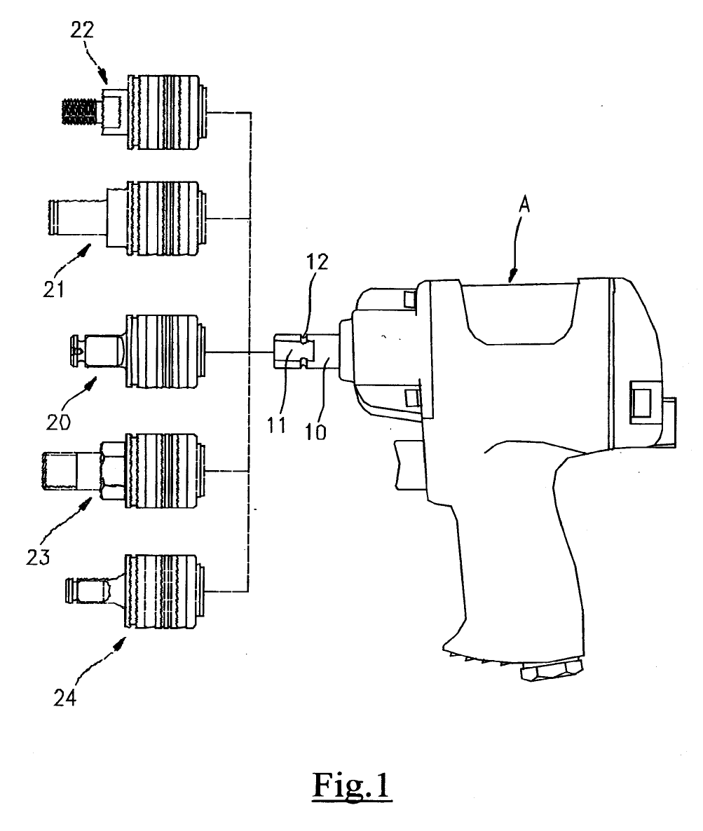

With reference to FIG. 1, an quick installment and removal tool anvil and adaptor assembly according to the present invention is designed to have the extending part of anvil (10) connected with the tool body (A) of air/electric driving tool.

The anvil (10) has a connection unit (or called as a connection flat) (11) extended at a front end thereof and the anvil (10) also has a dented groove (12) around a lateral circumference thereof, which is concave with an arc shape.

In view of FIG. 1, the anvil (10) is capable of being connected with one of different adaptors (20) to (24), i.e. the use of different adaptors (20) to (24) to connect with different tool heads (31) will have different functions.

The adaptor (20) as indicated in the drawing is used for impacting a wrench, the adaptor (21) being for a screwdriver, the adaptor (22) being for a drill, the adaptor (23) being for a sander, and the adaptor (24) being for an impact wrench.

The adaptors (20) to (24) are different in the tool heads (31) only, while the ends connected with the anvils (10) are identical.

For the convenience of illustration, the adaptor (20) for an impact wrench is as an example, while this is not used to confine the scope of the present invention.

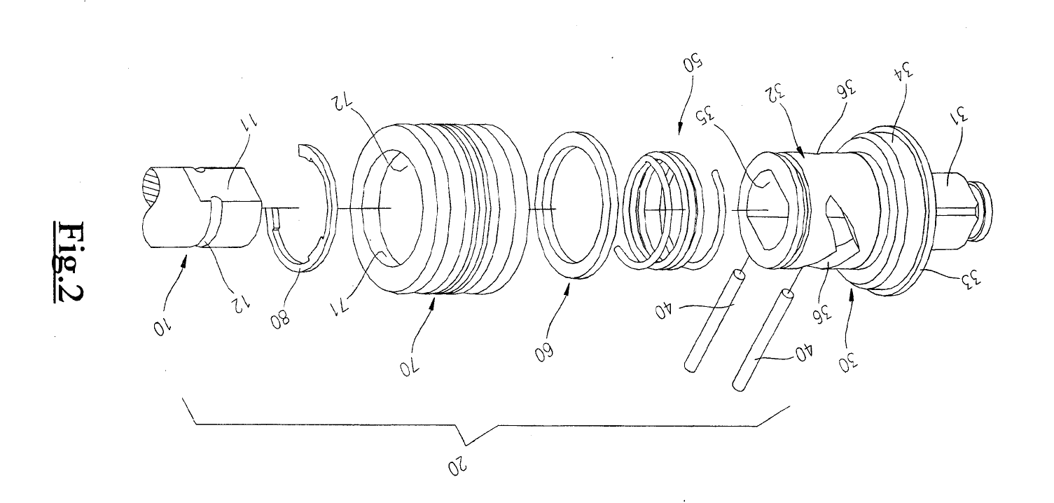

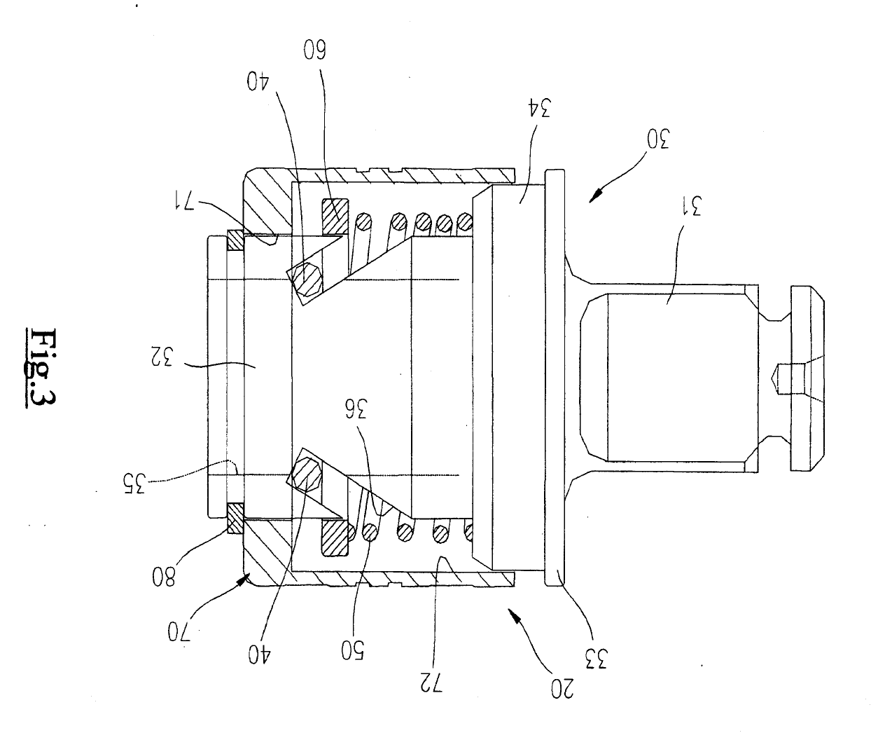

The adaptor (20) as illustrated in FIG. 2 and FIG. 3 comprises one shaft rod (30), two insert pins (40) threaded through the shaft rod (30), a spring (50) installed around the shaft rod (30), a washer (60) installed between the spring (50) and the insert pins (40), a cylinder body (70) enclosing the shaft rod (30), the spring (50), the washer (60) and the insert pins (40), and one collar (80) for stopping the shaft rod (30) from slipping off.

A lower side of the shaft rod (30) is formed as a shaft rod base (32) which is installed inside the cylinder body (70). A tool head 31 is installed above the shaft rod 30. The shape of tool head (31) will be different based on the functions to be applied.

A stop disk (33) having a greater external dimension then other portion of the shaft rod 30 is installed below the tool head (31) and a sleeve connection (34) is installed between the stop disk (33) and the shaft rod (32). The shaft rod (30) has an axial sleeve hole (35) and a circumferential wall of the shaft rod (30) has a cutting inclined groove (36) which is penetrated through the sleeve hole (35) for receiving the insert pins (40).

Both ends of insert pins (40) are slightly extended from the circumferential wall of shaft rod (30) so that the spring (50) around the shaft rod (30) and washer (60) are compressed and stopped between the insert pin (40) and the sleeve connection (34), and the insert pin (40) pressed by the power of spring (50) is, therefore, pushed to the bottom of cutting groove (36) through the washer (60).

A lower end of the cutting groove (36) is communicated to the sleeve hole (35) of shaft rod (30) so that the insert pin (40) would go through and stay in the sleeve hole (35) when it is placed in the bottom of cutting groove (36).

The cylinder body (70) is formed with an axial first sleeve hole (71) near a lower opening of the cylinder body (70) and an axial second sleeve hole (72) above the first sleeve hole (71). In assembly the shaft rod base (32) of shaft rod (30) is retained in the first sleeve hole (71) and other portion of the shaft rod (30) is retained in the second sleeve hole (72).

The shaft rod base (32) extended from the cylinder body (70) is fixed by the collar (80) so that the internal and external circumferential wall of the first sleeve hole (71) affected by the power of spring (50) will stay between the insert pin (40) and the collar (80); and an end of the second sleeve hole (72) is spaced from the stop disk (33) of the shaft rod (30).

The above-mentioned description is the introduction of the composing parts of the invented adaptor (20).

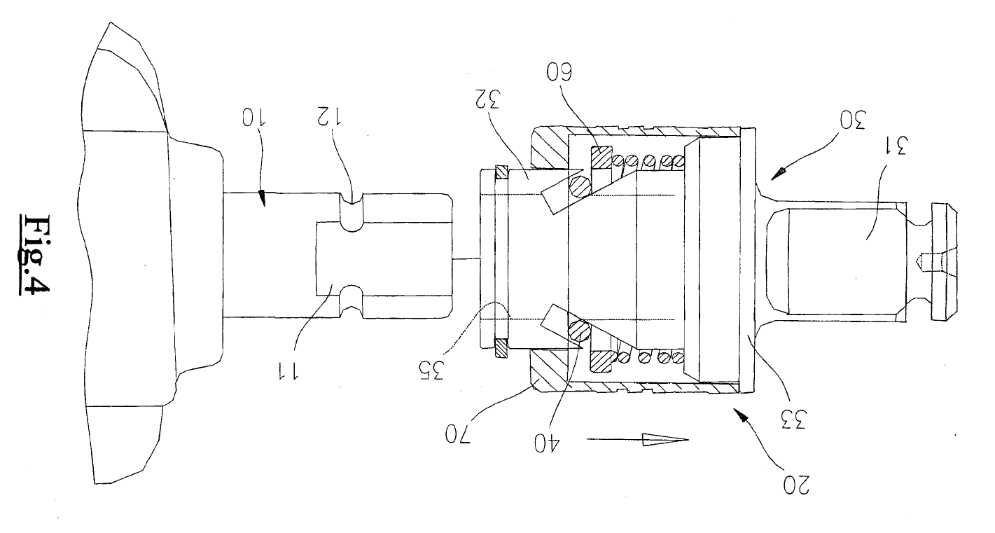

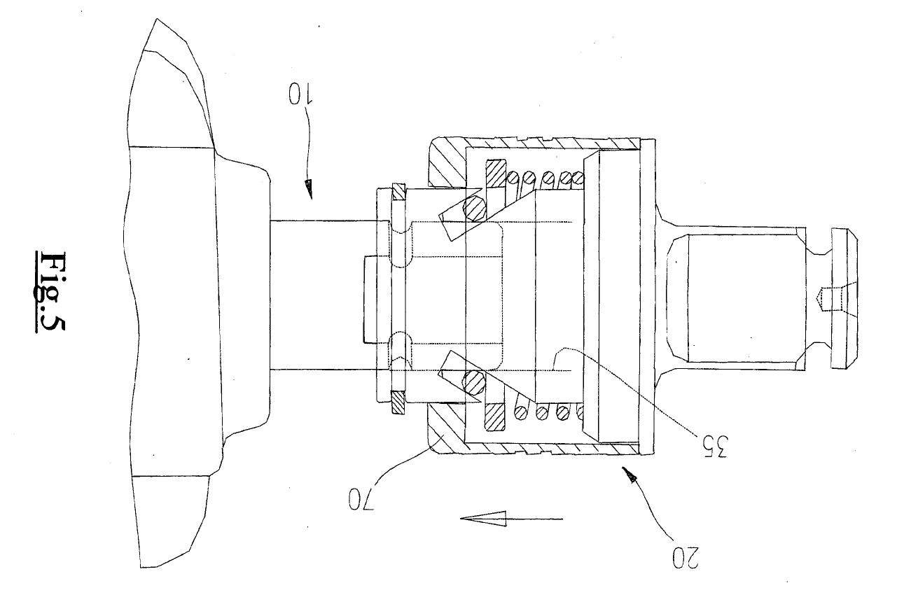

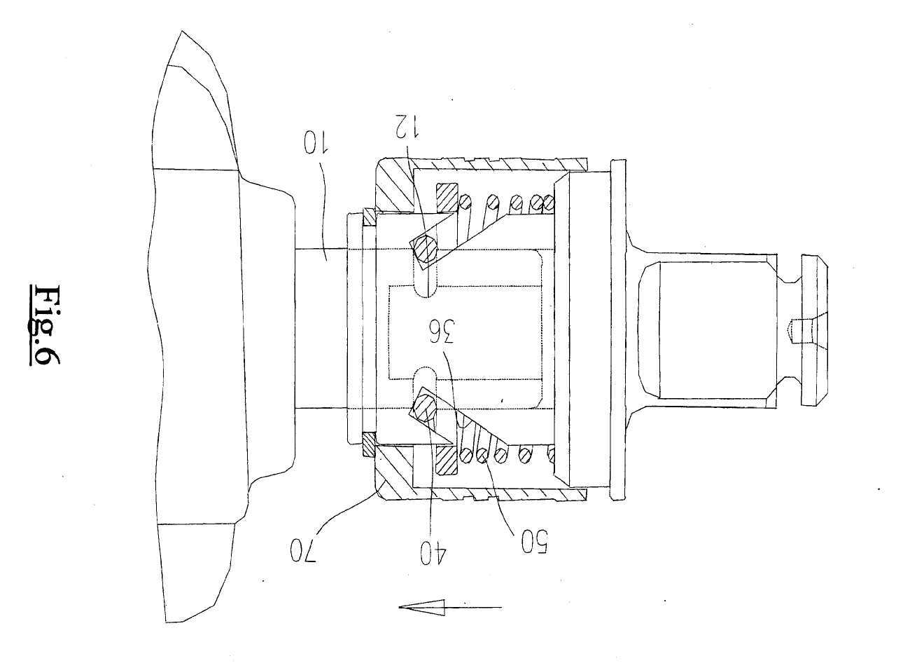

When connecting the adaptor (20) with the anvil (10) of the air/electric driving tool, as the cylinder body (70) is pushed, as indicated in FIG. 4, toward the stop disk (33) of the shaft rod (30) and the insert pin (40) is pushed out from the bottom of the cutting groove (36) to cause the insert pin (40) to leave from the sleeve hole (35) of the shaft rod (30), and place the adaptor (20) as shown in FIG. 5 by inserting the sleeve hole (35) of the shaft rod (30) to the anvil (10), and when the dented groove (12) of anvil (10), as shown in FIG. 6, is positioned in the bottom of cutting groove (36), the insert pin (40) simultaneously pushed by the power of spring (50) is reached to the bottom of cutting groove (36) and blocked in the dented groove (12) of the anvil (10) for avoiding the adaptor (20) slipping off.

FIG. 2 shows that the anvil (10) and the sleeve hole (35) of the shaft rod (30) are connected through the connection unit (11) with a non-round connection, so that a mutual driving operation is impossible; but the anvil (10) will drive the adaptor (20) to induce a rotation.

When update the adaptor with a different one, it only need push the cylinder body (70) of the adaptor (20) to the stop disk (33) of the shaft rod (30) and let the insert pin (40) loosen from the dented groove (12) of the anvil (10), then the anvil (10) will be removed.

It should understood that this invention will enable an operator to change the adaptors in accordance with the working requirements.

In other words, one tool body of the air/electric driving tool in conjunction with the adaptors of different functions will receive multi-functions without the spending of buying different tools.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A quick installment and removal tool anvil and adaptor assembly, comprising:
an anvil extending from a tool body of an air/electric driving tool, the tool anvil having an anvil body; a circumferential wall of the anvil body extending to a free end of a connection unit, and a circumference of anvil body in the connection unit being equipped with a vertically concave dented groove; and
an adaptor.

2. The quick installment and removal tool anvil and adaptor assembly as claimed in claim 1, wherein the dented groove has a ring shape.

3. A quick installment and removal tool anvil and adaptor assembly as claimed in claim 1, wherein the adaptor comprising:
a shaft rod (30), at least one insert pin (40) passing through the shaft rod (30); a lower side of the shaft rod (30) being formed as a shaft rod base (32); a tool head 31 being installed above the shaft rod 30; a stop disk (33) having a greater external dimension then other portion of the shaft rod 30 being installed below the tool head (31) and a sleeve connection (34) is installed between the stop disk (33) and the shaft rod (32); the shaft rod (30) having an axial sleeve hole (35) and a circumferential wall of the shaft rod (30) having a cutting inclined groove (36) which is penetrated through the sleeve hole (35) for receiving the insert pin (40); both ends of insert pin (40) slightly extending from the circumferential wall of shaft rod (30) so that the spring (50) around the shaft rod (30) and washer (60) are compressed and stopped between the insert pin (40) and the sleeve connection (34), and the insert pin (40) pressed by the power of spring (50) is, therefore, pushed to a bottom of cutting groove (36) through the washer (60); a lower end of the cutting groove (36) being communicated to the sleeve hole (35) of shaft rod (30) so that the insert pin (40) passes through and stays in the sleeve hole (35) when it is placed in the bottom of cutting groove (36);
a spring (50) installed around the shaft rod (30),
a washer (60) installed between the spring (50) and the insert pins (40); and
a cylinder body (70) enclosing the shaft rod (30), the spring (50), the washer (60) and the insert pins (40), and one collar (80) for stopping the shaft rod (30) from slipping off; the cylinder body (70) being formed with an axial first sleeve hole (71) near a lower opening of the cylinder body (70) and an axial second sleeve hole (72) above the first sleeve hole (71); in assembly the shaft rod base (32) of shaft rod (30) is retained in the first sleeve hole (71) and other portion of the shaft rod (30) is retained in the second sleeve hole (72).

4. A quick installment and removal tool anvil and adaptor assembly, comprising:
an anvil extending from a tool body of an air/electric driving tool, the tool anvil having an anvil body; a circumferential wall of the anvil body extending to a free end of a connection unit, and a circumference of anvil body in the connection unit being equipped with a vertically concave dented groove; and
an adaptor further comprising:
a shaft rod (30), at least one insert pin (40) passing through the shaft rod (30); a lower side of the shaft rod (30) being formed as a shaft rod base (32); a tool head 31 being installed above the shaft rod 30; a stop disk (33) having a greater external dimension then other portion of the shaft rod 30 being installed below the tool head (31) and a sleeve connection (34) is installed between the stop disk (33) and the shaft rod (32); the shaft rod (30) having an axial sleeve hole (35) and a circumferential wall of the shaft rod (30) having a cutting inclined groove (36) which is penetrated through the sleeve hole (35) for receiving the insert pin (40); both ends of insert pin (40) slightly extending from the circumferential wall of shaft rod (30) so that the spring (50) around the shaft rod (30) and washer (60) are compressed and stopped between the insert pin (40) and the sleeve connection (34), and the insert pin (40) pressed by the power of spring (50) is, therefore, pushed to a bottom of cutting groove (36) through the washer (60); a lower end of the cutting groove (36) being communicated to the sleeve hole (35) of shaft rod (30) so that the insert pin (40) passes through and stays in the sleeve hole (35) when it is placed in the bottom of cutting groove (36);
a spring (50) installed around the shaft rod (30),
a washer (60) installed between the spring (50) and the insert pins (40); and
a cylinder body (70) enclosing the shaft rod (30), the spring (50), the washer (60) and the insert pins (40), and one collar (80) for stopping the shaft rod (30) from slipping off; the cylinder body (70) being formed with an axial first sleeve hole (71) near a lower opening of the cylinder body (70) and an axial second sleeve hole (72) above the first sleeve hole (71); in assembly the shaft rod base (32) of shaft rod (30) is retained in the first sleeve hole (71) and other portion of the shaft rod (30) is retained in the second sleeve hole (72).
